(19) United States
(12) Patent Application Publication
(10) Pub. No.: US 2018/0129272 A1
(43) Pub. Date: May 10, 2018

(54) METHOD FOR CONTROLLING REMOTE ELECTRONIC DEVICE AND SYSTEM THEREOF

(71) Applicant: ALCORLINK CORP., Taipei (TW)

(72) Inventors: MING-HSUAN WU, TAIPEI (TW); HSIU-MING FAN, TAIPEI (TW)

(21) Appl. No.: 15/795,758

(22) Filed: Oct. 27, 2017

(30) Foreign Application Priority Data
Nov. 10, 2016 (TW) 105136544

(51) Int. Cl. G06F 3/00; H04N 7/18; H04N 7/10

(52) U.S. Cl. CPC G06F 3/005; G06F 3/03543; H04N 7/10; H04N 7/183

(57) ABSTRACT

The present invention provides a method for controlling a remote electronic device and the system thereof. According to the method and system, the input signals from an electronic device are transmitted to the remote electronic device via a camera device connected to the remote electronic device.

### FIELD OF THE INVENTION

The present invention relates generally to a method for controlling a remote electronic device and the system thereof, and particularly to a method for controlling a remote electronic device by transmitting input signals from an electronic device to the remote electronic device via a camera device and the system thereof.

### BACKGROUND OF THE INVENTION

In the modern society with a prosperous information technology (IT) industry, most companies in the industry will have technical or service interactions with other domestic or international companies. For such companies, they usually need to send employees to the fields for operating the computers of their partners. Unfortunately, this normally costs a lot of time on traffic. If the partners are located abroad, the charges for tickets and accommodations are massive expenses. Accordingly, some IT companies adopt the method of operating partners' computers by connecting to them through the Internet. Besides, there are many IT workers do their jobs at home or in coffee shops by connecting to company computers using their personal computers. In the current era when smartphones or personal digital assistants are equipped with powerful processing capability, there are even more people operate remote computers via smartphones or personal digital assistants. The technology of operating remote electronic devices via networks by using personal computers, smartphones, or personal digital assistants is called the controlremote control technology.

The controlremote control technology allows a user to control another electronic device located remotely via an electronic device. When the user uses an input device such as a mouse, keyboard, writing pad, plotting pad, trackball, or touch screen connected with the electronic device to generate an input signal, the electronic device will transmit the input signal to the remote electronic device via the network. The remote electronic device will execute according to the received input signal. Meanwhile, the remote electronic device will also transmit the images displayed currently on the display device of the remote electronic device to the user's electronic device. Thereby, the user can operate the remote electronic device directly and acquire the operating condition in the real time.

Nonetheless, this method undoubtedly exposes the remote electronic device in the network environment. Even the remote electronic device is normally protected by passwords, it is not guaranteed that an intended person won't break the passwords and invade the remote electronic device as well as all the other electronic devices in the local area network. To prevent the situation, most companies will limit remote operations by using network hardware or/and firewall. Once controlremote control is required, applications to the information security department of the companies are required. One cannot operate the electronic devices of the companies remotely without multiple approvements. The application process is generally time consuming and approvements are not guaranteed. In the fast-paced IT industry, minimum delays can result in massive loss to the companies. If urgent conditions such as server crashes occur and cannot be solved immediately, irremediable may result.

Besides, in some circumstances, the remote electronic device is located in an environment without network or suffering from network or booting problems. Then the current controlremote control technology cannot solve the problems eithers. Accordingly, it is urged to have a complete and secure controlremote control technology to solve the above problems.

### SUMMARY

An objective of the present invention is to provide a method for controlling remote electronic device and the system thereof. After a camera device shoots the display device of a remote electronic device to obtain an image, the camera device transmits the images to an electronic device. The electronic device transmits an input signal to the camera device. Then the camera device transmits the input signal to the remote electronic device for achieving the efficacy of controlremote control.

In order to achieve the above objective and efficacy, according to an embodiment of the present invention, a method for controlling remote electronic device is disclosed. The method comprises steps of: a camera device shooting a display device of a remote electronic device to obtain an image; the camera device transmitting the images to an electronic device; the electronic device transmitting an input signal to the camera device; and the camera device transmitting the input signal to the remote electronic device, and the remote electronic device executing according to the input signal.

According to an embodiment of the present invention, the camera device is connected to the remote electronic device via a hardware interface, and the input signal is transmitted to the remote electronic device via the hardware interface.

According to an embodiment of the present invention, the hardware interface is the universal serial bus (USB) interface, the IEEE 1394 interface, the PS/2 interface, the infrared transmission interface, or the Bluetooth transmission interface.

According to an embodiment of the present invention, the electronic device transmits the input signal according to the inputs of the input device connected to the electronic device.

According to an embodiment of the present invention, the input device is a mouse, a keyboard, a writing pad, a plotting pad, a trackball, or a touch screen.

According to an embodiment of the present invention, the camera device is connected to the electronic device via wired or wireless network.

In addition, according to an embodiment of the present invention, a system for controlling a remote electronic device is disclosed. The system comprises a remote electronic device, a camera device, and an electronic device. The remote electronic device includes a display device and a first hardware interface. The camera device includes a first network circuit, a second hardware interface, and a camera unit. The second hardware interface is connected with the first hardware interface. The camera unit shoots the display device to obtain an image and the images are transmitted via the first network circuit. The electronic device includes a second network circuit and transmits an input signal to the camera device via the second network circuit. The camera device transmits the input signal to the remote electronic device via the second hardware interface. The electronic device receives the images via the second network circuit.

According to an embodiment of the present invention, the first and second hardware interfaces are the USB interfaces, the IEEE 1394 interfaces, the PS/2 interfaces, the infrared transmission interfaces, or the Bluetooth transmission interfaces.

According to an embodiment of the present invention, the electronic device includes an input device and transmits the input signal according to the inputs of the input device.

According to an embodiment of the present invention, the input device is a mouse, a keyboard, a writing pad, a plotting pad, a trackball, or a touch screen.

### BRIEF DESCRIPTION OF THE DRAWINGS

FIG. 1 shows a flowchart of the method for controlling a remote electronic device according to the first embodiment of the present invention;

FIG. 2 shows a schematic diagram of the system for controlling a remote electronic device according to the first embodiment of the present invention; and

FIG. 3 shows a schematic diagram of the system for controlling a remote electronic device according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The controlremote control technology according to the prior art exposes remote electronic devices in the network environment and leads to loopholes in information security. To avoid security loopholes, the problems in electronic device cannot be solved remotely and promptly. Accordingly, the present invention provides a method for controlling remote electronic device and the system thereof.

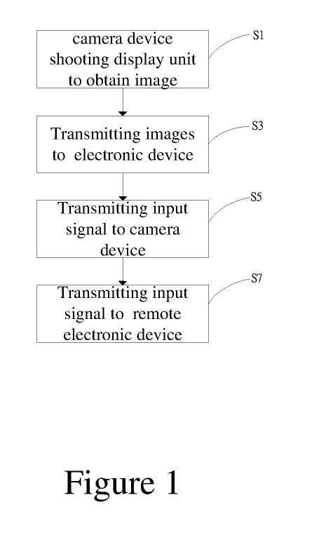

Here, the process of the method for controlling a remote electronic device according to the first embodiment of the present invention will be described. Please refer to FIG. 1, which shows a flowchart of the method for controlling a remote electronic device according to the first embodiment of the present invention. As shown in the figure, the method for controlling a remote electronic device according to the present embodiment comprises steps of:

Step S1: camera device shooting display device to obtain image;
Step S3: Transmitting images to electronic device;
Step S5: Transmitting input signal to camera device; and
Step S7: Transmitting input signal to remote electronic device.

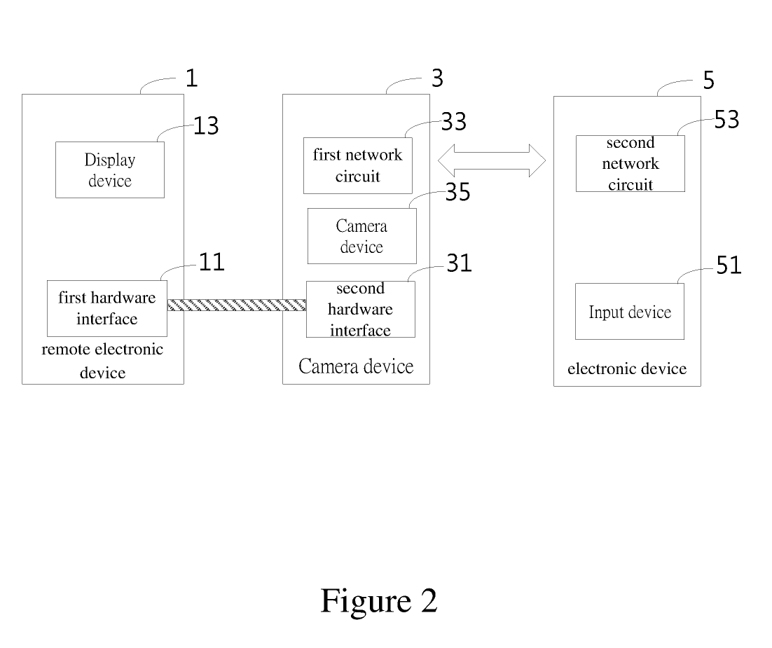

Next, the system for achieving the method for controlling a remote electronic device according to the present invention will be described. Please refer to FIG. 2, which shows a schematic diagram of the system for controlling a remote electronic device according to the first embodiment of the present invention. As shown in the figure, the system for controlling a remote electronic device according to the present invention comprises a remote electronic device 1, a camera device 3, and an electronic device 5. The remote electronic device 1 includes a hardware interface 11 and a display device 13. The camera unit includes a second hardware interface 31, a first network circuit 33, and a camera unit 35. The electronic device 5 includes an input device 51 and a second network circuit 53. The remote electronic device 1 and the electronic device 5 described above can be electronic devices such as smartphones, personal digital assistants (PDA), tablet computers, notebook computers, and desktop computers.

In the following, the first hardware interface 11 and the second hardware interface 31 will be described. They are the media between hardware components for transmitting or receiving signals, and can be the USB interfaces, the IEEE 1394 interfaces, the PS/2 interfaces, the infrared transmission interfaces, or the Bluetooth transmission interfaces.

According to the present embodiment, the remote electronic device 1 and the camera device 3 are connected via the first and second hardware interfaces 11, 31.

Next, the display device 13 will be described. The display device 13 is connected electrically to the remote electronic device 1 and used for displaying the current operation frames of the remote electronic device 1. The display device 13 can be a liquid crystal display, a plasma display, a cathode-ray tube display, an LED array, a touch screen, or other displays capable of displaying information for users.

Next, the first and second network circuits 33, 53 will be described. The first network circuit 33 enables the camera device 3 to connect to the network in a wired or wireless method; the second network circuit 53 enables the electronic device 5 to connect to the network in a wired or wireless method.

Next, the camera unit 35 will be described. The camera unit 35 can be a charge-coupled device (CCD), a CMOS active pixel sensor, a video camera tube, or any other devices capable of converting optical images into electronic signals. By using the camera unit 35, images will be produced.

In the following, the process of executing the method for controlling remote electronic device according to the first embodiment of the present invention will be described. Please refer to FIG. 1 and FIG. 2. To control the remote electronic device 1, the steps S1 through S7 will be executed.

In the step S1, the camera device 3 shoots the display device 13 to give images. The camera device 3 uses the camera unit 35 to shoot the display device 13 of the remote electronic device 1 to give the images. In other words, the camera unit 35 will shoot the current displaying frames of the display device 13.

In the step S3, transmit the images to the electronic device 5. The camera device 3 uses the first network circuit 33 to transmit the images via the network. The electronic device 5 uses the second network circuit 53 to receive the images transmitted by the camera device 3.

In the step 5, transmit the input signal to the camera device 3. The input device 51 of the electronic device 5 transmits an input signal to the camera device 3. For example, when the input device 51 is a mouse, the input signal can be pointer movement, left clicking, right clicking, or scrolling. When the input device 51 is a keyboard, the input signal can be any key press or any other input signal entered from the keyboard.

In the step S7, transmit the input signal to the remote electronic device 1. The camera device 3 transmits the input signal via the second hardware interface 31 to the first hardware interface 11 of the remote electronic device 1. After the remote electronic device 1 receives the input signal, it executes according to the input signal. Namely, when a user moves the mouse of the electronic device 1 to generate an input signal of pointer movement, the remote electronic device 1 will move the pointer according to the input signal as soon as it receives the input signal.

Then the method for controlling remote electronic device according to the first embodiment of the present invention is completed. Because the input signal of the electronic device us transmitted to the remote electronic device via the camera device, the electronic device controls the remote electronic device indirectly via the camera device. In the process of indirect control, it is not required for the electronic device to have the administration permission. Thereby, in the remote electronic device with limited user permission, the camera device can be connected to the remote electronic device via the hardware interfaces. Then the method for controlling remote electronic device according to the present invention can be adopted for control.

In addition, if the remote operations of the remote electronic device are limited by the network hardware equipment or/and firewall, the first network circuit of the camera device can be instead connected to another network, such as the mobile network shared by mobile base station of a smartphone. Then the electronic device can connect with the camera device for remote operations. Under urgent conditions, it is not required to have approvements from the information security department of the company before the network hardware equipment or/and firewall is opened for remote operations. Hence, the system problems of the remote electronic device can be handled promptly. After the problem is solved, the information security department need not reset the network hardware equipment or/and firewall for disabling remote operations. The only task is to remove the camera device connected to the remote electronic device.

Furthermore, when the remote electronic device is equipment not connected to the network, such as storage equipment for confidential data, or the problem to be solved is just the networking problem of the remote electronic device, the method for controlling remote electronic device according to the present invention can be adopted for control.

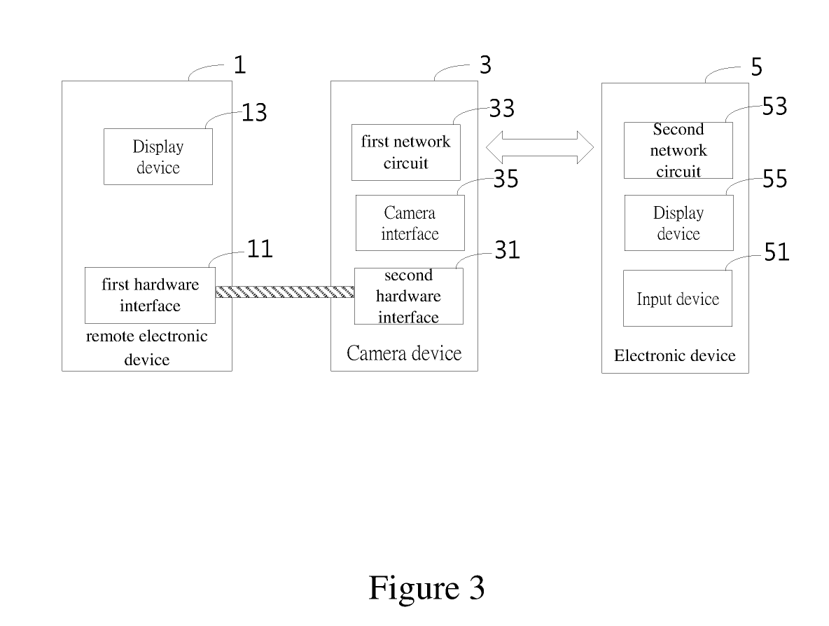

Next, the method for controlling remote electronic device according to the second embodiment of the present invention will be described. Please refer to FIG. 3, which shows a schematic diagram of the system for controlling a remote electronic device according to the second embodiment of the present invention. The difference between the system according to the present embodiment and the one according to the first embodiment is that the electronic device 5 according to the present embodiment further comprises a display device 55. The rest of the system is identical to the one according to the first embodiment. Hence, the details will not be described again.

The display device 55 is connected electrically to the electronic device 5 and used for displaying the current operation frames of the electronic device 5. The display device 55 can be a liquid crystal display, a plasma display, a cathode-ray tube display, an LED array, a touch screen, or other displays capable of displaying information for users.

According to the present embodiment, in the step S3, as the electronic device 5 receives the images transmitted by the camera device 3, the electronic device 5 will display the received images on the display device 55 so that the user of the electronic device 5 can acquire the current operating conditions of the remote electronic device 1.

In the following, the scenario of using the method for controlling remote electronic device according to the second embodiment of the present invention will be illustrated. Please refer to FIGS. 1 and 3. When a user needs to operate a remote server (equivalent to the remote electronic device 1) connected with a network camera (equivalent to the camera device 3) via a personal computer (equivalent to the electronic device 5), the network camera first shoots the screen (equivalent to the display device 13) of the server to give an image of the current displaying frame (equivalent to the step S1). A first network circuit (equivalent to the first network circuit 33) of the network camera transmits the image to the personal computer via the network. When a second network circuit (equivalent to the second network circuit 53) of the personal computer receives the image transmitted by the network camera via the network, the received image is displayed on the screen (equivalent to the display device 55) of the personal computer, so that the user can acquire the current operation frame of the server (equivalent to the step S3).

The user presses the key “A” of the keyboard (equivalent to the input device 53) of the personal computer. Then the keyboard generates the input signal and transmits it to the personal computer. The personal computer transmits the input signal to the network camera (equivalent to the step S5) through the network via the second network circuit. After the network camera receives the input signal, it transmits the input signal to the USB port (equivalent to the first hardware interface 11) of the server via its USB port (equivalent to the second hardware interface 31). The server then inputs “A” according to the input signal and displays “A” on the screen of the server (equivalent to the step S7). Hence, the method for controlling remote electronic device according to the second embodiment of the present invention is completed.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A method for controlling remote electronic device, comprising steps of:
a camera device shooting a display device of a remote electronic device to obtain an image;
said camera device transmitting said image to an electronic device;
said electronic device transmitting an input signal to said camera device; and
said camera device transmitting said input signal to said remote electronic device, and said remote electronic device executing an action according to said input signal.

2. The method for controlling remote electronic device of claim 1, wherein said camera device is connected to said remote electronic device via a hardware interface and said input signal is transmitted to said remote electronic device via said hardware interface.

3. The method for controlling remote electronic device of claim 2, wherein said hardware interface is the universal serial bus interface, the IEEE 1394 interface, the PS/2 interface, the infrared transmission interface, or the Bluetooth transmission interface.

4. The method for controlling remote electronic device of claim 1, wherein said electronic device transmits said input signal according to the input of an input device connected with said electronic device.

5. The method for controlling remote electronic device of claim 4, wherein said input device is a mouse, a keyboard, a writing pad, a plotting pad, a trackball, or a touch screen.

6. The method for controlling remote electronic device of claim 1, wherein said camera device is connected to said electronic device via a wired or wireless network.

7. A system for controlling remote electronic device, comprising:
a remote electronic device, including a display device and a first hardware interface;
a camera device, including a first network circuit, a second hardware interface, and a camera interface, said second hardware interface connected with said first hardware interface, and said camera unit shooting said display device to obtain an image and transmitting said image via said first network circuit; and
an electronic device, including a second network circuit, and transmitting an input signal to said camera device via said second network circuit;
where said camera device transmits said input signal to said remote electronic device via said second hardware interface; and said electronic device receives said image via said second network circuit.

8. The system for controlling remote electronic device of claim 7, wherein said first hardware interface and said second hardware interface are the universal serial bus interfaces, the IEEE 1394 interfaces, the PS/2 interfaces, the infrared transmission interfaces, or the Bluetooth transmission interfaces.

9. The system for controlling remote electronic device of claim 7, wherein said electronic device includes an input device and transmits said input signal according to the input of said input device.

10. The system for controlling remote electronic device of claim 9, wherein said input device is a mouse, a keyboard, a writing pad, a plotting pad, a trackball, or a touch screen.
